(19) United States
(12) Patent Application Publication
(10) Pub. No.: US 2007/0211352 A1
(43) Pub. Date: Sep. 13, 2007

(54) Aperture changing apparatus and method

(75) Inventors: Alton H. Phillips, East Palo Alto, CA (US); Douglas C. Watson, Campbell, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Nikon Corporation

(21) Appl. No.: 11/372,824

(22) Filed: Mar. 9, 2006

(51) Int. Cl. G02B 9/00

(52) U.S. Cl. 359/738

(57) ABSTRACT

An apparatus for rotating apertures from a storage position not in a desired plane to a “in use” position in a desired plane. The stored position of the apertures does not interfere with a radiation beam path of an optical system. The apparatus may compactly store multiple apertures and may position a smaller aperture in a desired plane without removing a larger aperture from the desired plane.

### BACKGROUND

1. Technical Field

Embodiments disclosed herein relate to an apparatus for and method of compactly storing and changing fixed dimension apertures used in a desired plane of an optical system, such as in a lithography tool.

2. Related Art

In some optical systems, apertures of fixed dimensions are used rather than, for example, a single expandable or contractible aperture to limit light therein. At times, different sized and shaped apertures are needed and the aperture in use must be removed and the new one positioned in its place. Current lithography tools use rotary exchangers to make the change. Rotary exchangers typically have a single plate in which all apertures are located. All apertures, both in use and stored, are in the desired plane of use. However, the stored apertures, while in the desired plane of use, are not positioned over an optical element, but are rotated into position as needed. The same rotation that positions a new aperture over an optical element removes the previously used aperture from the position over the optical element. Thus, the apertures are exchanged by rotation of the plate containing the apertures.

A rotary exchanger may interfere with the beam path during an extreme ultra-violet lithography (“EUVL”) exposure operation, and it may consume valuable space that could otherwise be used by structural members for supporting and connecting optical elements. There is a need to compactly store and change fixed diameter apertures used in an optical system of an EUVL tool.

### SUMMARY

As broadly described herein, embodiments consistent with the invention can include an aperture positioner, an aperture changer, a method of positioning apertures, and a method of using a series of apertures without first removing an earlier-used aperture.

An aperture positioner according to some embodiments of the invention for use in an optical system having a radiation beam path can include a member having a fixed-dimension aperture for use in a desired plane and one or more movers coupled to the member to rotate the aperture from a first position not within the desired plane to a second position substantially within the desired plane, wherein, in the first position, the member does not interfere with the radiation beam path of the optical system.

An aperture changer according to some embodiments of the invention for use in an optical system having a radiation beam path can include a first member having an aperture of fixed dimension, d₁, for use in a desired plane and a first one or more movers coupled to the first member to rotate the aperture of fixed dimension, d₁, from a first position not in the desired plane to a second position substantially within the desired plane. The aperture changer can also include a second member having an aperture of fixed dimension, d₂, for use in the desired plane, where d₂<d₁, and a second one or more movers coupled to the second member to rotate the aperture of fixed dimension, d₂, from a third position not in the desired plane to a fourth position substantially within the desired plane. In the first and third positions, respectively, the first and second members do not interfere with the radiation beam path of the optical system.

A method of positioning an aperture according to some embodiments consistent with the invention, in an optical system having a radiation beam path, can include rotating a member having an aperture of fixed dimension to be used in a desired plane from a first position not in the desired plane to a second position substantially within the desired plane. In the first position, the member does not interfere with the radiation beam path of the optical system.

A method of using a series of fixed-dimension apertures without removing an earlier-used aperture according to some embodiments of the invention can include 1) rotating a first member having an aperture of a fixed-dimension, d₁, from a first position not in a desired plane into a second position, where the aperture of fixed dimension d₁ is in the desired plane and 2) rotating a second member having a tubular projection defining an aperture of a fixed dimension, d₂, where d₂<d₁, from a third position not in the desired plane into a fourth position, where the aperture of fixed dimension d₂ is in the desired plane and within the aperture of fixed dimension d₁.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings,

FIG. 1 shows a side view of an aperture positioner according to some embodiments of the invention with an aperture positioned in a desired plane over an object;

FIG. 2 shows a top view of the aperture positioner shown in FIG. 1, but oriented differently relative to the radiation beam path;

FIG. 3 shows another side view of the aperture positioner shown in FIGS. 1 and 2 with the aperture member in a position not interfering with a beam of radiation incident on the object;

FIG. 4 shows a top view of an aperture changer according to some embodiments of the invention with an incident and reflected beam of radiation;

FIG. 5 shows a cross-sectional side view of the aperture exchanger shown in FIG. 4 along line 5-5 with two apertures positioned in a desired plane over an object;

FIG. 6 shows a front view of another aperture exchanger according to some embodiments of the invention with five aperture members in positions that do not interfere with a beam of radiation;

FIG. 7 shows a partial cross-sectional side view of the five aperture members shown in FIG. 7 along the line 7-7;

FIG. 8 shows a perspective view of another aperture changer according to some embodiments of the invention;

FIG. 9 shows an assembly of two aperture changers according to some embodiments of the invention as mounted to an XY slide along with an object 30;

FIG. 10 shows a diagram of a lithography system according to some embodiments of the invention;

FIG. 11 is a block diagram of a process of fabricating semiconductor devices;

FIG. 12 is a detailed flow chart of step 1004 of the process shown in FIG. 11.

### DETAILED DESCRIPTION

Reference will now be made in detail to exemplary embodiments consistent with the invention, which are illustrated in the accompanying drawings. Wherever possible, the same reference numbers will be used throughout the drawings to refer to the same or like parts.

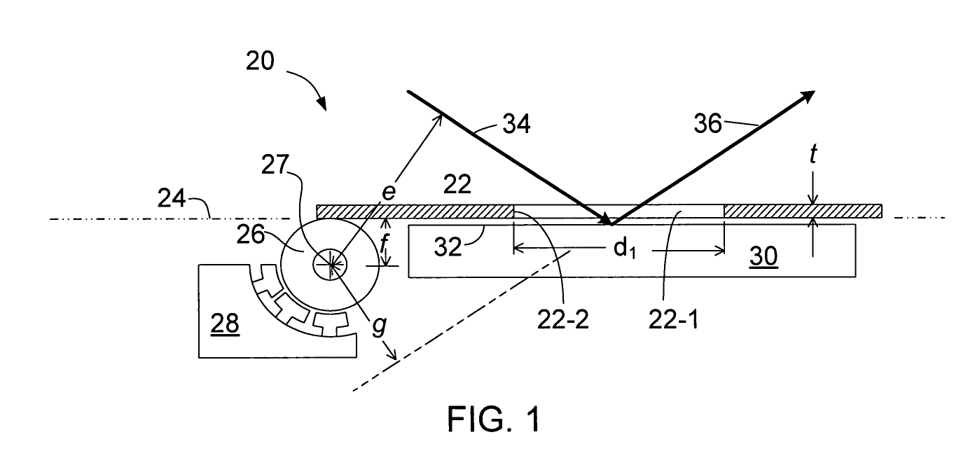

FIG. 1 illustrates an aperture positioner 20 according to some embodiments of the invention with an aperture plate 22 having a thickness t and a through-hole 22-1 containing an aperture 22-2 of fixed diameter d₁ located on a surface of aperture plate 22. In FIG. 1, aperture 22-2 is positioned in a desired plane 24 over an object 30. Desired plane 24 may be an intermediate focal plane of an optical system. In some embodiments, object 30 may have a reflective surface 32. In some embodiments, aperture 22-2 exposes part of object 30 to an incident radiation beam 34, of which at least a portion reflects off reflective surface 32 to form a reflected radiation beam 36.

Aperture 22-2 may be rotated into desired plane 24. In some embodiments, aperture plate 22 may be coupled to one or more movers 26, depicted in FIG. 1 as a stepper motor, for rotation about an axis of rotation 27. Stepper motors are well known in the art and need not be described in more detail. An example of a stepper motor that will suffice to rotate an aperture in an aperture plate into position in a desired plane is a 3 phase stepper motor. In some embodiments, one or more movers 26 may be mounted on a bracket 28, in a manner well known in the art.

In some embodiments, including the one illustrated in FIG. 1, axis of rotation 27 may be parallel to desired plane 24. As illustrated in FIG. 1, incident beam 34 has, approximately, a 30 degree angle of incidence with object 30. Incident beam 34 is illustrated perpendicular to axis of rotation 27, in a parallel plane at a distance labeled by “e”. As illustrated, axis of rotation 27 is below desired plane 24 a distance labeled by “f”. As illustrated, reflected beam 36 is contained in a plane a distance “g” from axis of rotation 27.

In some embodiments, axis of rotation 27 may not be parallel to desired plane 24. If the axis of rotation 27 is not parallel to desired plane 24, then the distance “e” between axis of rotation 27 and incident beam 34 and/or the distance “g” between axis of rotation 27 and reflected beam 36 may need to be greater to prevent portions of aperture plate 22 (in a stored position 90 degrees from an operational position) from interfering with incident beam 34 or reflected beam 36. If a non parallel axis of rotation is chosen, then aperture plate 22 may need to be further rotated (>90 degrees, for example) to prevent interference. If the axis of rotation 27 is parallel to desired plane 24, the volume required for aperture positioner 20 to rotate aperture plate 22 may be minimized.

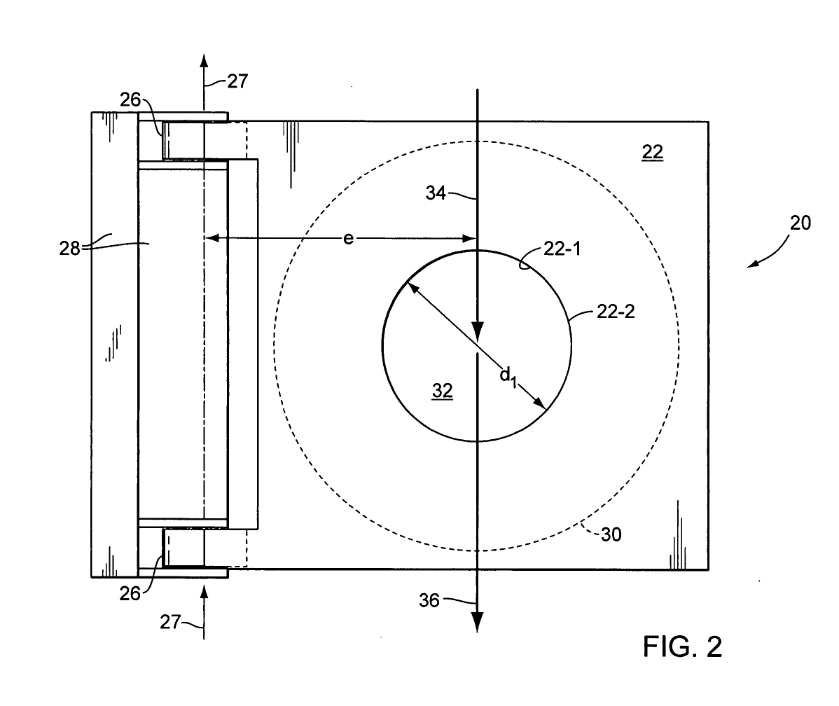

FIG. 2 illustrates a top view of the aperture positioner 20 illustrated in FIG. 1, except that the axis of rotation 27 of aperture plate 22 is parallel to incident radiation ray 34 in the plane containing incident radiation ray 34 at a distance labeled by “e.” If the axis of rotation 27 is not parallel to plane containing the incident radiation beam (ray), or the intended incident beam path if radiation is not present, then the distance “e” between axis of rotation 27 and plane containing incident beam 34 and/or the distance “g” between axis of rotation 27 and reflected beam 36 may need to be greater to prevent portions of aperture plate 22 (in a stored position 90 degrees from an operational position) from interfering with incident beam 34 or reflected beam 36. If a non-parallel axis of rotation is chosen, then aperture plate 22 may need to be further rotated (>90 degrees, for example) to prevent interference. If the axis of rotation 27 is parallel to the incident beam 34 and the plane containing incident beam 34, the volume required for aperture positioner 20 to rotate an aperture plate may be minimized.

As shown in FIG. 2, in some embodiments, two movers 26 may be coupled to aperture plate 22 to position aperture 22-2 in a desired plane 24 over object 30. In some embodiments, one mover coupled with a clutch and belt system could rotate aperture plate 22 from use position to a different, storage position.

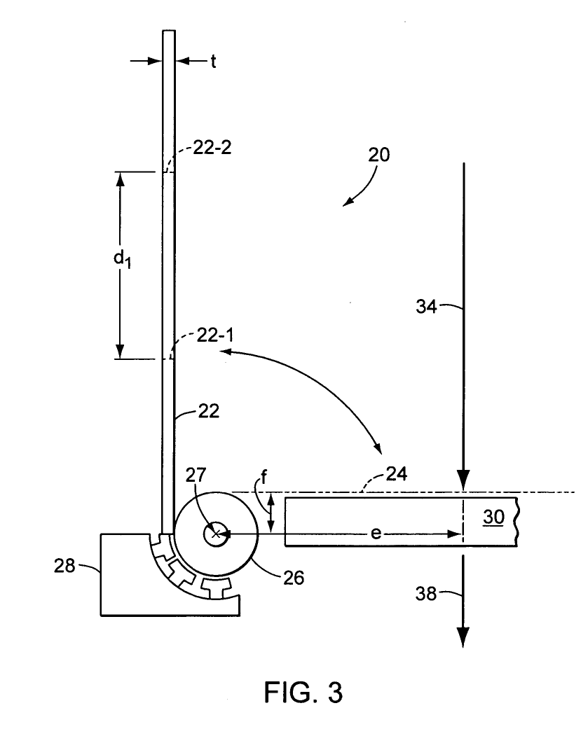

FIG. 3 illustrates a side view of the aperture positioner 20 illustrated in FIG. 2 with the aperature plate in a storage position (not in use). In FIG. 3, incident radiation ray 34 is perpendicular to axis of rotation 27, perpendicular to desired plane 24, and in a plane parallel to axis of rotation 27. In some embodiments, object 30 may be transmissive to incident radiation and may transmit a portion of incident ray 34 as transmitted (refracted) radiation ray 38. As shown in FIG. 3, aperture plate 22 may be positioned by aperture positioner 20 in a position that is not in desired plane 24 and that does not interfere with incident radiation ray 34. In some embodiments, that position may be 90 degrees from, or, in other words, perpendicular to, desired plane 24, but can be at some other angle if the aperture plate does not interfere with the intended beam path, whether incident, reflected, or refracted.

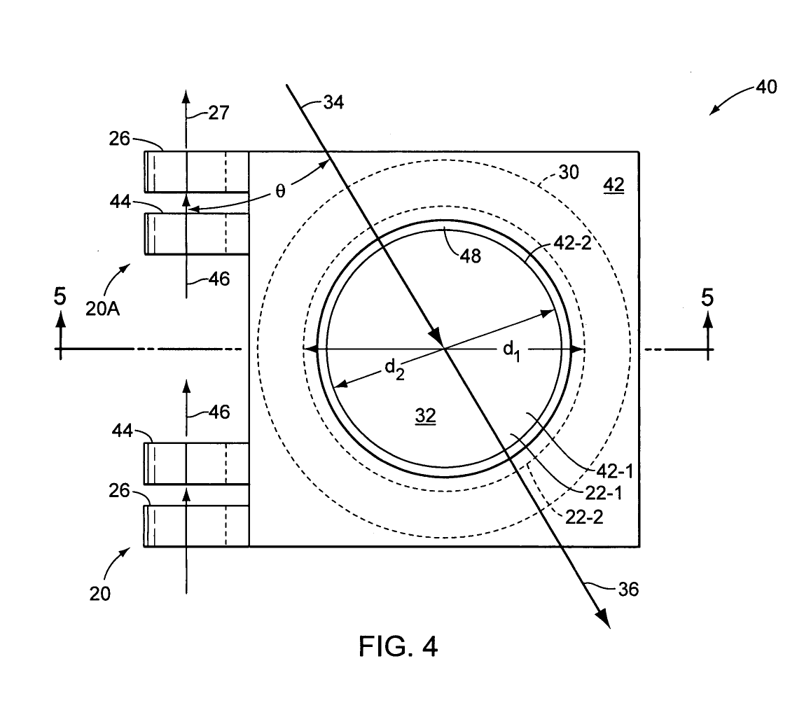

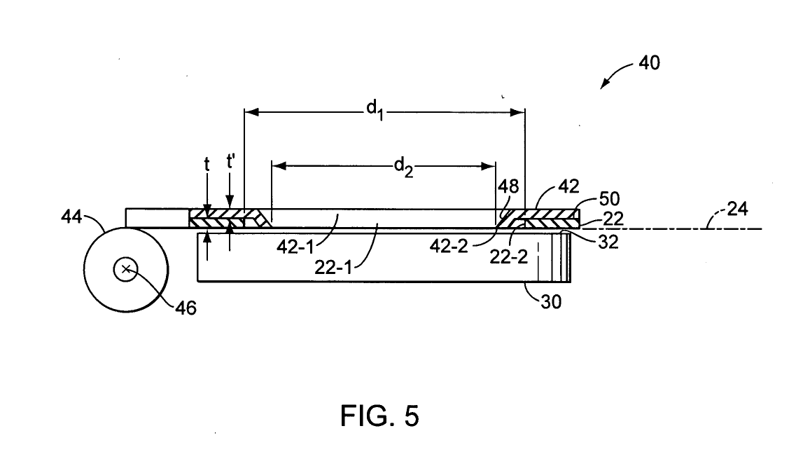

FIG. 4 illustrates a top view of an aperture changer 40 according to some embodiments of the invention. In some embodiments, aperture changer 40 may include multiple aperture positioners. In FIG. 4, aperture changer 40 includes aperture positioner 20, as illustrated in FIGS. 1-3, and a second aperture positioner 20A. Aperture positioner 20 includes two movers 26 coupled to aperture plate 22 (not shown) that is under aperture plate 42 and has an aperture 22-2 of fixed diameter d₁, illustrated by dotted line. In some embodiments, aperture positioner 20A includes two movers 44 coupled to aperture plate 42 having a through-hole 42-1 that includes an aperture 42-2 of fixed diameter d₂, where d₂<d₁. In some embodiments, aperture plate 42 includes a portion 48 that defines aperture 42-2. In some embodiments, portion 48 may have a conical, tubular shape (best illustrated in FIG. 5) the dimensions of which may be determined in part by the incidence angle of the incident radiation beam as well as the dimensions of through-hole 22-1 of aperture plate 22 that includes diameter d₁ (aperture 22-2).

Here, it may be seen that aperture plate 42 may rotated by movers 44 about an axis of rotation 46 aligned with axis of rotation 27. Axis of rotation 46 may be parallel, in some embodiments, to desired plane 24. FIG. 4 illustrates aperture 22-2 and aperture 42-2 positioned in desired plane 24 over object 30 (illustrated as the largest diameter, dotted-line circle). FIG. 4 illustrates an incident radiation beam 34 that reflects off reflective surface 32 of object 30 as reflected beam 36. In some embodiments and as shown in FIG. 4, axes of rotations 27 and 46 form an angle theta, θ, of 30 degrees with a plane containing the incident radiation beam path, including incident beam 34.

FIG. 5 illustrates a cross-sectional side view of aperture changer 40 illustrated in FIG. 4 along line 5-5. In some embodiments, aperture changer 40 includes aperture plate 22 having a thickness t and a through-hole 22-1 containing an aperture 22-2 of fixed diameter d₁ positioned in desired plane 24 over object 30 with reflective surface 32. In FIG. 5, aperture plate 42, having a thickness t and a through-hole 42-1 that includes an aperture 42-2 of fixed diameter d₂ is positioned with a bottom surface 50 adjacent to and touching a top surface of aperture plate 22 below it. In some embodiments, portion 48 of aperture plate 42 defines both through-hole 42-1 and aperture 42-2 and extends a thickness t into through-hole 22-1 containing aperture 22-2 in aperture plate 22, such that aperture 42-2 is substantially positioned in desired plane 24 within aperture 22-2.

FIGS. 4 & 5 illustrate that, in some embodiments, aperture changer 40 may be used to position a series of apertures in a desired plane 24 without removing an earlier used aperture(s).

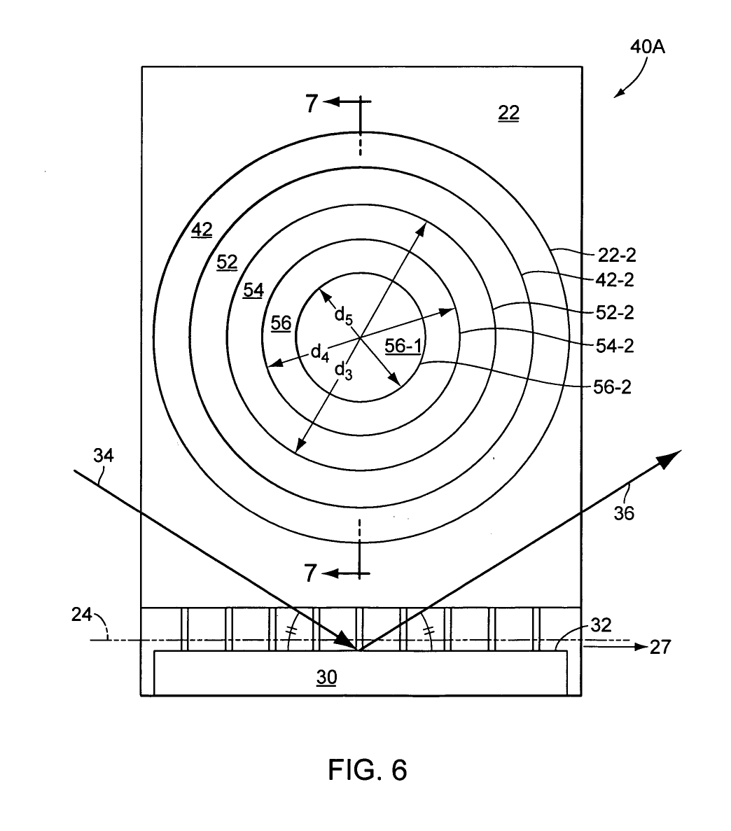

FIG. 6 illustrates a front view of another aperture changer 40A of aperture positioners according to some embodiments of the invention. As illustrated here, aperture plates 22, 42, 52, 54, and 56 are shown in a position that does not interfere with an incident beam 34 or reflected beam 36 from reflective surface 32 of object 30. Aperture plates 22 and 42 and their accompanying movers have been previously described. Each aperture plate may be coupled to one or more movers that may rotate the aperture plate from the illustrated position to a position where the fixed diameter of the at least one aperture therein may substantially be in desired plane 24.

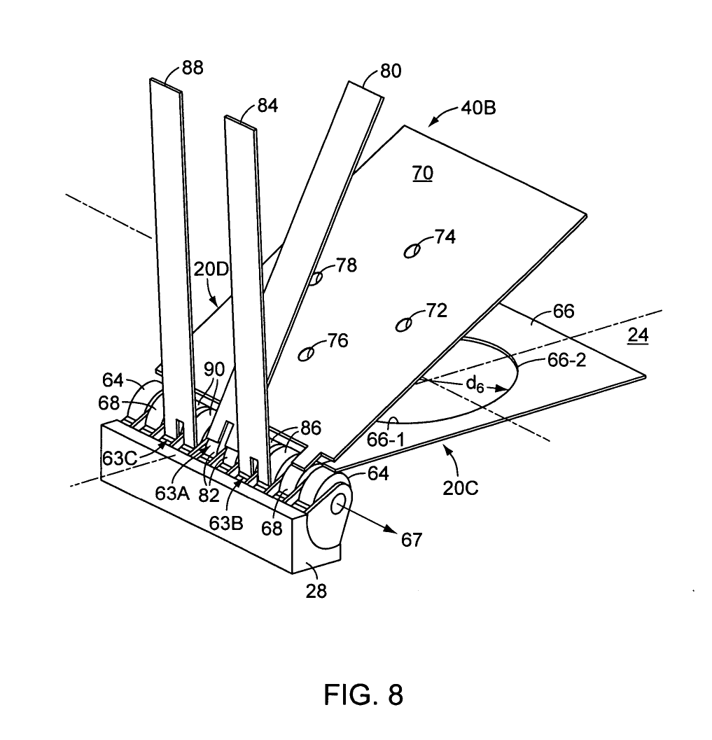

If diameter d₃ Of the at least one aperture of aperture plate 52 is smaller than the fixed diameter d₂ of aperture 42-2 of aperture plate 42, then fixed diameter d₃ (aperture 52-2) may be positioned in a desired plane 24 over object 30 without removing aperture plate 22 or aperture plate 42. For simplicity's sake, only the fixed diameter aperture of each aperture plate is shown. Relevant details of the projections of the aperture plates that extend into the through-holes of lower aperture plates (with larger apertures) are illustrated in FIG. 8. Again, in some embodiments, aperture changer 40A may be used to use a series of apertures in addition to the aperture of aperture plate 22 without removing the earlier used aperture(s).

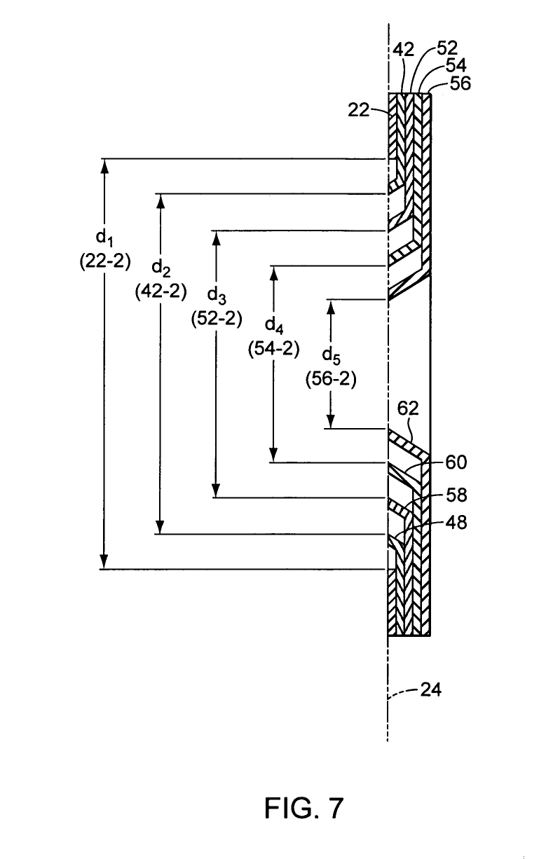

FIG. 7 illustrates a partial cross-sectional side view of the series of aperture plates shown in FIG. 7, in more detail. As illustrated in this figure, five plates with fixed, circular apertures may be positioned such that each of the five apertures are in a desired plane 24. In this figure, it may be seen that conical, tubular projections of aperture plates 42, 52, 54, and 56, extend into the through-hole(s) in the lower positioned aperture plate(s). Portion 48 of aperture plate 42 extends, as previously described with respect to FIG. 5, such that aperture 42-2 of fixed diameter d₂ is in the same plane as aperture 22-2 of fixed diameter d₁ of aperture plate 22. Similarly, aperture plate 52 has a through-hole 52-1 that includes an aperture 52-2 of fixed diameter d₃ that is smaller than that of diameter d₂, and portion 58 of aperture plate 52 extends such that aperture 52-2 is in the same plane as aperture 22-2. Likewise, aperture plate 54 has a through-hole 54-1 that includes an aperture 54-2 of fixed diameter d₄ smaller than diameter d₃ and portion 60 extends such that aperture 54-2 is in the same plane as aperture 22-2 of fixed diameter d₁ of aperture plate 22. Finally, aperture plate 56 has a through-hole 56-1 that includes an aperture 56-2 of fixed diameter d₅ smaller than diameter d₄ and portion 62 extends such that aperture 56-2 is in the same plane as aperture 22-2. In some embodiments, aperture plates will be in contact with one another as illustrated by the layered aperture plates when their respective apertures are in the same plane.

FIG. 8 illustrates another aperture changer 40B according to some embodiments of the invention. Aperture changer 40B, in this embodiment, includes aperture positioner 20C, aperture positioner 20D, and three blind positioners 63A, 63B, and 63C. Specifically, FIG. 8 illustrates aperture positioner 20C that includes two movers 64 coupled to aperture plate 66 and mounted in bracket 28. In this embodiment, aperture plate 66 has a through-hole 66-1 that includes an aperture 66-2 of fixed diameter d₆ and is rotated by movers 64 about an axis of rotation 67. FIG. 8 also illustrates aperture positioner 20D that includes two movers 68 also mounted in bracket 28 and coupled to dipole plate 70 having four dipole apertures 72, 74, 76, and 78 of fixed diameter. As may be seen in FIG. 8, movers 68 may be aligned with movers 64, such that dipole plate 70 is also rotated about axis 67. As in FIGS. 1-3, in FIG. 4, axis of rotation 67 is parallel to desired plane 24.

FIG. 8 illustrates three blinds that may be used in conjunction with dipole plate 70. A first blind 80 may be coupled to one or more movers 82, and in some embodiments, two movers may be coupled to blind 80. Blind 80 may be rotated from a position not interfering with an incident radiation path into a position interfering with the incident radiation path for at least one dipole aperture on dipole plate 70. In some embodiments, blind 80 may cover dipole aperture 74 and 76 when blind 80 is positioned above dipole plate 70 and parallel to desired plane 24. A second blind 84 may be coupled to one or more movers 86. In some embodiments, two movers may be coupled to blind 84. Blind 84 may be rotated from a position not interfering with an incident radiation path into a position interfering with the incident radiation path for at least one dipole aperture on dipole plate 70. In some embodiments, blind 84 may cover dipole plate aperture 72 when blind 84 is positioned above dipole plate 70 and parallel to desired plane 24. A third blind 88 may be coupled to one or more movers 90. In some embodiments, two movers may be coupled to blind 88. Blind 88 may be rotated from a position not interfering with an incident radiation path into a position interfering with the incident radiation path for at least one dipole plate aperture on dipole plate 70. In some embodiments, blind 88 may cover dipole aperture 78 when blind 88 is positioned above dipole plate 70 and parallel to desired plane 24.

Dipole plate 70 may be positioned over both object 30 and aperture plate 66 and still function for its intended purpose. As with aperture plates 42, 52, 54 and 56 described in conjunction with FIGS. 5 and 7, dipole plate 70 may include portions defining apertures 72 through 78 that project (extend) into through-hole 66-1 in aperture plate 66 to desired plane 24, when dipole plate 70 is rotated into position over aperture plate 66. Again, in some embodiments, a series of apertures may be used without removing an earlier used aperture plate. In some embodiments, aperture plate 66 need not be removed from its position having aperture 66-2 in desired plane 24 for dipole plate 70 to be rotated into position for use such that apertures 72 through 78 are also in desired plane 24.

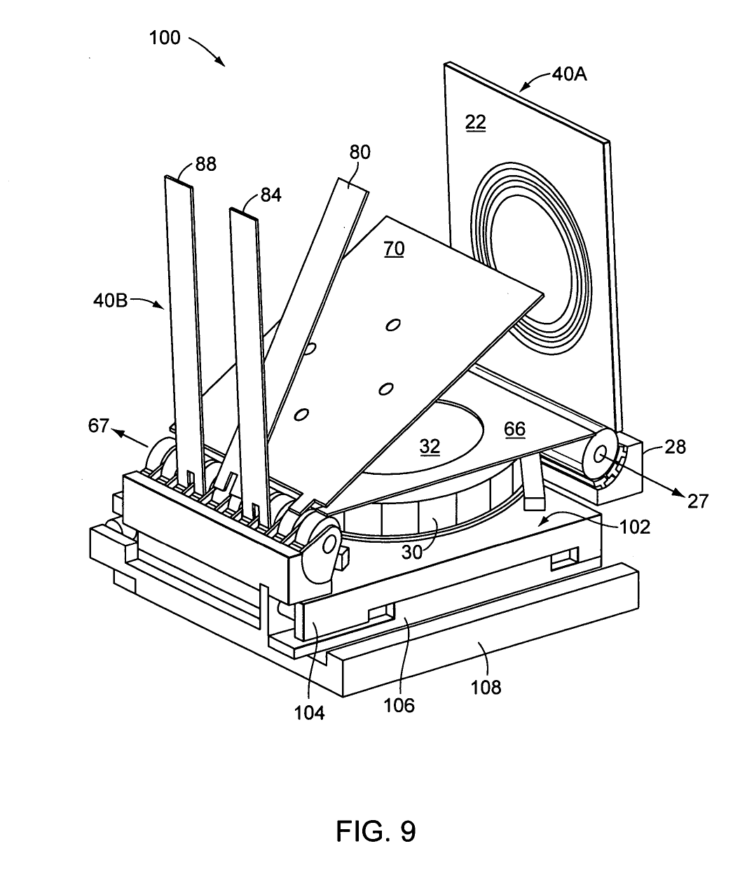

FIG. 9 illustrates an assembly 100 of aperture changers 40A and 40B as illustrated in FIGS. 4-7 and 8, respectively, as mounted on an X-Y slide 102 for positioning and changing apertures in a desired plane over an object 30 with a reflective surface 32. As is well know in the art and need not be described further herein, X-Y slide 102 may contain three plates 104, 106, and 108 separated by bearings to provide separate motion along the X and Y axes.

As previously described, aperture plate 66, dipole plate 70, and blinds 80, 84, and 88 rotate about axis 67. As previously described, aperture plates of aperture changer 40A (22, 42, 52, 54, and 56, shown, but not all labeled) rotate about axis 27. FIG. 9 illustrates aperture 66-2 positioned in a desired plane over object 30. In FIG. 9, five fixed-diameter aperture plates, as previously described in conjunction with FIGS. 6 & 7, are illustrated in an upright position approximately 90 degrees from aperture 66-2 and positioned such that they will not interfere with incident radiation on object 30.

In some embodiments, a first aperture changer 40A may be mounted 180 degrees from a second aperture changer 40B, with the first axis of rotation 27 parallel to the second axis of rotation 67 and the first and second axes of rotation 27 and 67, respectively, being parallel to the desired plane and the plane containing the intended radiation beam path. In some embodiments, but not one illustrated, a first aperture changer 40A may be mounted 90 degrees from a second aperture changer 40B, with axis of rotation 27 perpendicular to second axis of rotation 67, but both axes of rotation 27 and 67 being parallel to the desired plane and only one being parallel to the plane containing the intended radiation beam path.

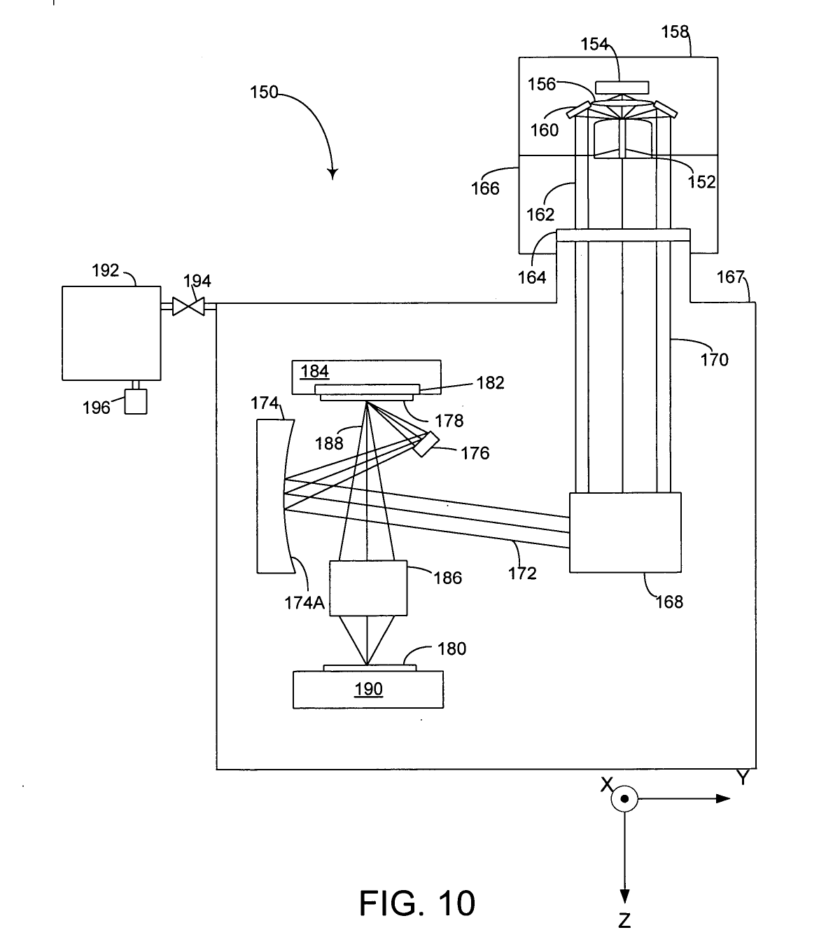

Referring to wafer processing equipment, FIG. 10 illustrates one example of an EUV (or soft-X-ray “SXR”) lithographic exposure system 150. The depicted system 150 is configured to perform microlithographic exposures in a step-and-scan manner. The depicted system 150 is a projection-exposure system that performs step-and-scan lithographic exposures using light in the extreme ultraviolet (“soft X-ray”) band, typically having a wavelength in the range of λ=11-14 nm (nominally 13 nm). Lithographic exposure involves directing an EUV illumination beam to a pattern-defining reticle 178. The illumination beam reflects from reticle 178 while acquiring an aerial image of the pattern portion defined in the illuminated portion of reticle 178. The resulting “patterned beam” is directed to an exposure-sensitive substrate 180, which upon exposure becomes imprinted with the pattern.

The EUV beam can be produced by a laser-plasma source 152 excited by a laser 154 situated at the most upper end of the depicted system 150. Laser 154 can generate laser light at a wavelength within the range of near-infrared to visible. For example, laser 154 can be a YAG or an excimer laser. Laser light emitted from laser 154 can be condensed by a condensing optical system 156 and directed to downstream laser-plasma source 152.

A nozzle (not shown), disposed in laser-plasma light source 152, can discharge xenon gas. As the xenon gas is discharged from the nozzle in laser-plasma light source 152, the gas is irradiated by the high-intensity laser light from the condensing optical system 156. The resulting intense irradiation of the xenon gas can cause sufficient heating of the gas to generate a plasma. Subsequent return of Xe molecules to a low-energy state can result in the emission of SXR (EUV) radiation with good efficiency having a wavelength of approximately 13 nm.

Since EUV light has low transmissivity in air, its propagation path preferably may be enclosed in a vacuum environment produced in a vacuum chamber 158. Also, since debris tends to be produced in the environment of the nozzle from which the xenon gas is discharged, vacuum chamber 158 desirably can be separated from other chambers of system 150.

A paraboloid mirror 160, provided with, for example, a surficial multi-layer Mo/Si coating, can be disposed relative to laser-plasma source 152 so as to receive EUV light radiating from laser plasma source 152 and to reflect the EUV light in a downstream direction as a collimated beam 162. The multi-layer film on parabolic mirror 160 can be configured to have high reflectivity for EUV light of which X=approximately 13 nm.

Collimated beam 162 passes through a visible-light-blocking filter 164 situated downstream of the parabolic mirror 160. By way of example, filter 164 can be made of beryllium (Be), with a thickness of about 0.15 nm. Of the EUV radiation 162 reflected by parabolic mirror 160, only the desired 13 nm wavelength of radiation passes through filter 164. Filter 164 is contained in a vacuum chamber 166 evacuated to high vacuum.

An exposure chamber 167 can be situated downstream of pass filter 164. Exposure chamber 167 can contain an illumination-optical system 168 that comprises at least a condenser-type mirror and a fly-eye-type mirror (not shown, but well understood in the art). Illumination-optical system 168 may include at least one aperture positioner consistent with the invention to position an aperture above the at least one fly-eye type mirror. Illumination-optical system 168 may include at least one aperture changer consistent with the invention to position at least one aperture of fixed dimension over a fly-eye type mirror and to store at least one other aperture or blind in a position that does not interfere with the EUV beam path. It should be noted that other optical elements within a lithography tool may also use an aperture positioner or aperture changer consistent with the invention.

Illumination-optical system 168 also can be configured to shape EUV beam 170 (propagating from filter 164) to have an arc-shaped transverse profile. Shaped “illumination beam” 172 can be irradiated toward the left in FIG. 9 and can be received by mirror 174.

Mirror 174 can have a circular, concave reflective surface 174A, and be held in a vertical orientation (in the figure) by holding members (not shown). Mirror 174 can be formed from a substrate made, e.g., of quartz or low-thermal-expansion material such as Zerodur (Schott). Reflective surface 174A is shaped with extremely high accuracy and coated with a Mo/Si multi-layer film that is highly reflective to EUV light. Whenever EUV light having a wavelength in the range of 10 to 15 nm is used, the multi-layer film on surface 174A can include a material such as ruthenium (Ru) or rhodium (Rh) to protect the multilayer from oxidation with minimal reflectivity loss. Other candidate materials to reflect EUV light are silicon, beryllium (Be), and carbon tetraboride (B₄C).

A bending mirror 176 can be disposed at an angle relative to mirror 174, and can be shown to the right of mirror 174 in FIG. 6. Reflective reticle 178, that can define a pattern to be transferred lithographically to the substrate 180, can be situated “above” bending mirror 176. Note that reticle 178 can be oriented horizontally with a reflective surface directed downward to avoid deposition of any debris on the patterned surface of reticle 178. Illumination beam 172 of EUV light emitted from illumination-optical system 168 can be reflected and focused by mirror 174, and can reach the reflective surface of reticle 178 via bending mirror 176.

Reticle 178 typically has an EUV-reflective surface configured as a multi-layer film. Pattern elements, corresponding to pattern elements to be transferred to the substrate (or “wafer”) 180, are defined on or in the EUV-reflective surface. Reticle 178 can be mounted via a reticle chuck 182 on a reticle stage 184 that is operable to hold and position reticle 178 in at least the X- and Y- axis directions as required for proper alignment of reticle 178 relative to the substrate 80 for accurate exposure. Reticle stage 184 can, in some embodiments, be operable to rotate reticle 178 as required about the Z-axis. The position of reticle stage 184 is detected interferometrically in a manner known in the art. Hence, illumination beam 172 reflected by bending mirror 176 is incident at a desired location on the reflective surface of reticle 178.

A projection-optical system 186 and substrate 180 are disposed downstream of reticle 178. Projection-optical system 186 can include several EUV-reflective mirrors, blinds, and apertures. Patterned beam 188 from reticle 178, carrying an aerial image of the illuminated portion of reticle 178, can be “reduced” (demagnified) by a desired factor (e.g., ¼) by projection-optical system 186 and is focused on the surface of substrate 180, thereby forming a latent image of the illuminated portion of the pattern on substrate 180. So as to form the image carried by the patterned beam 188, the upstream-facing surface of the substrate 180 can be coated with a suitable resist.

Substrate 180 can be mounted by an electrostatic or other appropriate mounting force via a substrate “chuck” (not shown but well understood in the art) to a substrate stage 190. Substrate stage 190 can be configured to move the substrate chuck (with attached substrate) in the X-direction, Y-direction, and theta Z (rotation about the Z axis) direction relative to the projection-optical system 186, in addition to the three vertical DOF as described in conjunction with the z actuators as described and claimed in U.S. Provisional Application No. 60/625,420, which is incorporated herein by reference in its entirety for all purposes. Desirably, substrate stage 190 can be mounted on and supported by vibration-attenuation devices. The position of the substrate stage 190 can be detected interferometrically, in a manner known in the art.

A pre-exhaust chamber 192 (load-lock chamber) is connected to exposure chamber 167 by a gate valve 194. A vacuum pump 196 is connected to pre-exhaust chamber 192 and serves to form a vacuum environment inside pre-exhaust chamber 192.

During a lithographic exposure performed using the system shown in FIG. 10, EUV light 172 is directed by illumination-optical system 168 onto a selected region of the reflective surface of reticle 178. As exposure progresses, reticle 178 and substrate 180 are scanned synchronously (by their respective stages 184, 190) relative to projection-optical system 186 at a specified velocity ratio determined by the demagnification ratio of projection-optical system 186. Normally, because not all of the pattern defined by reticle 178 can be transferred in one “shot,” successive portions of the pattern, as defined on reticle 178, are transferred to corresponding shot fields on substrate 180 in a step-and-scan manner. By way of example, a 25 mm×33 mm rectangle can be exposed on substrate 180 with an IC pattern having a 0.07 μm line spacing at the resist on substrate 180.

Coordinated and controlled operation of system 150, as is well known in the art, is achieved using a controller (not shown) coupled to various components of system 150 such as illumination-optical system 168, reticle stage 184, projection-optical system 186, and substrate stage 190. For example, the controller operates to optimize the exposure dose on substrate 180 based on control data produced and routed to the controller from the various components to which the controller is connected, including various sensors and detectors (not shown).

Many of the components and their interrelationships in this system are known in the art, and hence are not described in detail herein.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

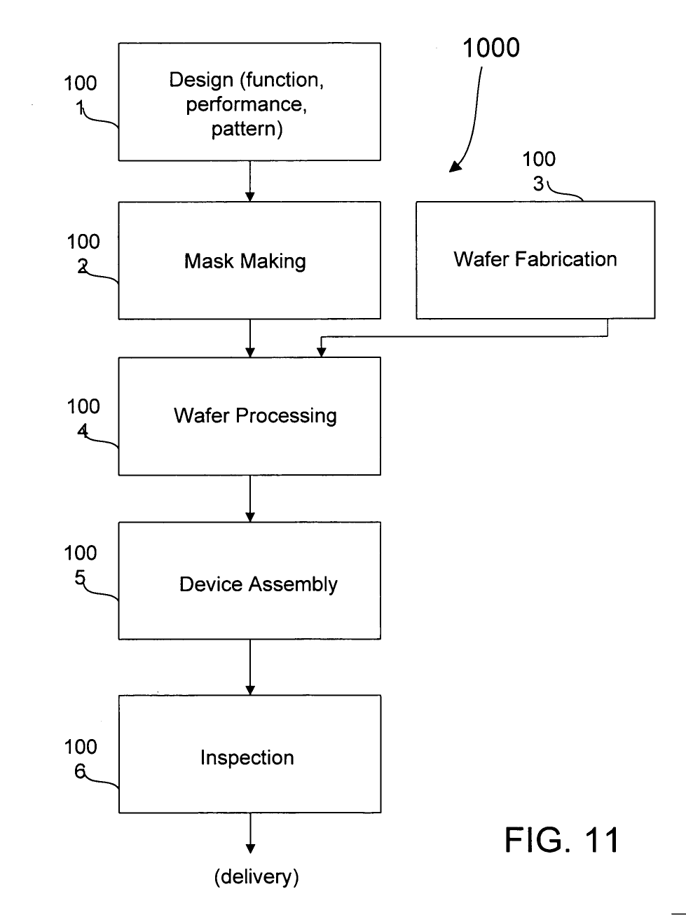

Further, semiconductor devices can be fabricated using the above described systems, by process 1000 shown generally in FIG. 11. In step 1001, the device's function and performance characteristics are designed. Next, in step 1002, a mask (reticle) having a pattern designed according to the previous designing step. In a parallel step 1003, a wafer is made from a silicon material. The mask pattern designed in step 1002 is exposed onto the wafer from step 1003 in step 1004 by a photolithography system described hereinabove according to the principles of the present invention. In step 1005, the semiconductor device is assembled (including the dicing process, bonding process and packaging process), then finally the device is inspected in step 1006.

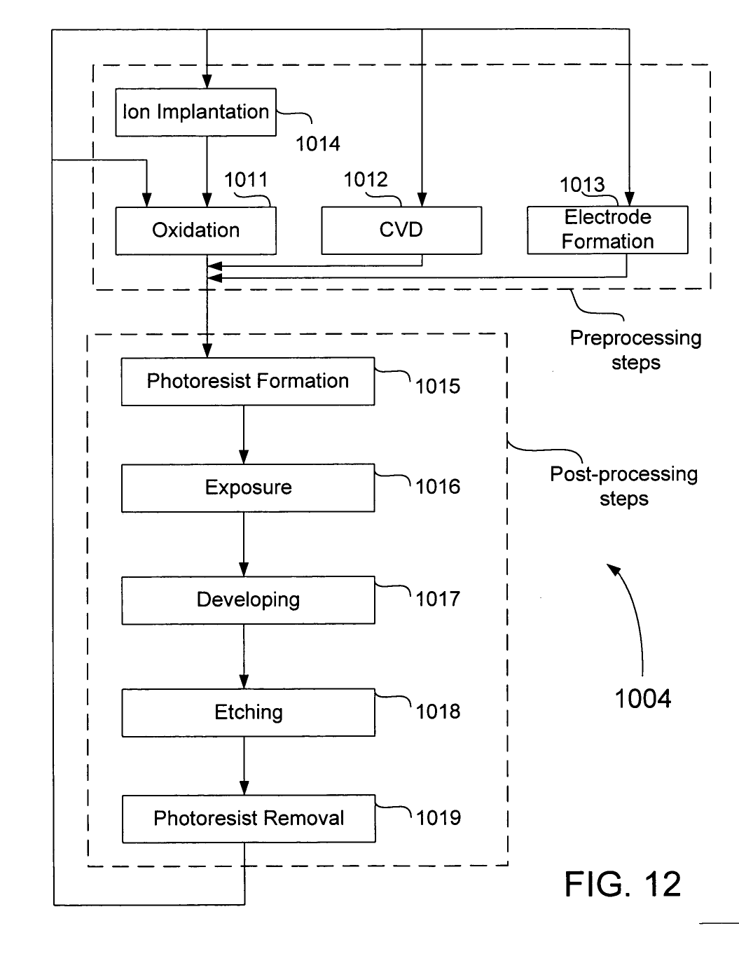

FIG. 12 illustrates a detailed flowchart example of the above-mentioned step 1004 in the case of fabricating semiconductor devices. In step 1011 (oxidation step), the wafer surface is oxidized. In step 1012 (CVD step), an insulation film is formed on the wafer surface. In step 1013 (electrode formation step), electrodes are formed on the wafer by vapor deposition. In step 1014 (ion implantation step), ions are implanted in the wafer. The above mentioned steps 1011-1014 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 1015 (photoresist formation step), photoresist is applied to a wafer. Next, in step 1016, (exposure step), the above-mentioned exposure device is used to transfer the circuit pattern of a mask (reticle) to a wafer. Then, in step 1017 (developing step), the exposed wafer is developed, and in step 1018 (etching step), parts other than residual photoresist (exposed material surface) are removed by etching. In step 1019 (photoresist removal step), unnecessary photoresist remaining after etching is removed.

Multiple circuit patterns are formed by repetition of these preprocessing and post-processing steps.

Other embodiments consistent with some embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An aperture positioner for use in an optical system having a radiation beam path, the aperture positioner comprising:
a member having an aperture of fixed dimension for use in a desired plane; and
one or more movers coupled to the member to rotate the aperture from a first position not in the desired plane to a second position substantially within the desired plane,
wherein, in the first position, the member does not interfere with the radiation beam path of the optical system.

2. The aperture positioner of claim 1, wherein an axis of rotation of the aperture is parallel to the desired plane.

3. The aperture positioner of claim 1, wherein the first position is perpendicular to the desired plane.

4. The aperture positioner of claim 1, wherein an axis of rotation of the aperture is parallel to a plane containing an incident radiation beam.

5. The aperture positioner of claim 1, wherein at least one of the one or more movers is a stepper motor.

6. The aperture positioner of claim 5, wherein two stepper motors are coupled to the member.

7. The aperture positioner of claim 1, wherein the member is a dipole plate including at least two dipole apertures.

8. An aperture positioner for use in an optical system having a radiation beam path, the aperture positioner comprising:
a member having an aperture of fixed dimension for use in a desired plane; and
means for rotating the aperture from a first position not in the desired plane to a second position substantially within the desired plane, the means for rotating coupled to the member,
wherein, in the first position, the member does not interfere with the radiation beam path of the optical system.

9. The aperture positioner of claim 8, wherein the first position is ninety degrees from the second position.

10. The aperture positioner of claim 8, wherein an axis of rotation of the aperture is parallel to a plane containing an incident radiation beam.

11. The aperture positioner of claim 8, wherein means for rotating comprises a stepper motor.

12. The aperture positioner of claim 11, wherein means for rotating comprises two stepper motors.

13. The aperture positioner of claim 8, wherein the member is a dipole plate including at least two dipole apertures.

14. An aperture changer for use in an optical system having a radiation beam path, the aperture changer comprising:
a first member having an aperture of fixed dimension, d₁, for use in a desired plane;
a first one or more movers coupled to the first member to rotate the aperture of fixed dimension, d₁, from a first position not in the desired plane to a second position substantially within the desired plane;
a second member having an aperture of fixed dimension, d₂, for use in the desired plane, where d₂<d₁; and
a second one or more movers coupled to the second member to rotate the aperture of fixed dimension, d₂, from a third position not in the desired plane to a fourth position substantially within the desired plane,
wherein, in the first and third positions, respectively, the first and second members do not interfere with the radiation beam path of the optical system.

15. The aperture changer of claim 14, wherein an axis of rotation of the first member is parallel to an axis of rotation of the second member.

16. The aperture changer of claim 14, wherein a direction of rotation from the first position to the second position is opposite a direction of rotation from the third position to the fourth position.

17. The aperture changer of claim 14, wherein an axis of rotation of the first member is the same as an axis of rotation of the second member.

18. The aperture changer of claim 14, wherein the first member need not be rotated from the second position in order for the second member to be rotated from the third position to the fourth position.

19. The aperture changer of claim 18, wherein the second member comprises a conical, tubular projection that defines an aperture of fixed diameter d₂.

20. The aperture changer of claim 14 further comprising:
at least one blind coupled to a third one or more movers, having the same axis of rotation as at least one of the first and second members, and arranged to interfere with the radiation beam path of the optical system when rotated into a second desired plane.

21. The aperture changer of claim 8, wherein the first member in the first position is adjacent to the second member in the third position.

22. The aperture changer of claim 8, wherein the first member in the second position is adjacent to the second member in the fourth position.

23. A method of positioning an aperture in an optical system having a radiation beam path comprising:
rotating a member having an aperture of fixed dimension to be used in a desired plane from a first position not in the desired plane to a second position substantially within the desired plane,
wherein, in the first position, the member does not interfere with the radiation beam path of the optical system.

24. The method of claim 17 further comprising:
coupling the member to be positioned to one or more movers; and
wherein the member rotating step includes rotating a portion of the one or more movers from a third position corresponding to the coupled member's first position to a fourth position corresponding to the coupled member's second position.

25. The method of claim 17, wherein the member is rotated about a line parallel to the desired plane.

26. The method of claim 17, wherein the member is rotated about a line parallel to a plane containing an incident beam path of the optical system.

27. A method of using a series of fixed-dimension apertures without removing an earlier-used aperture comprising:
rotating a first member having an aperture of a fixed-dimension, d₁, from a first position not in a desired plane into a second position, where the aperture of fixed dimension d₁ is in the desired plane; and
rotating a second member having a tubular projection defining an aperture of a fixed dimension, d₂, where d₂<d₁, from a third position not in the desired plane into a fourth position, where the aperture of fixed dimension d₂ is in the desired plane;
wherein the aperture of fixed dimension d₂ is within the aperture of fixed dimension d₁.
